(19) United States
(12) Patent Application Publication
(10) Pub. No.: US 2026/0185445 A1
(43) Pub. Date: Jul. 2, 2026

(54) METHOD FOR CONTROLLING AUTOMATIC OPERATION OF MINING ELECTRIC SHOVEL CONSIDERING SUDDEN LOAD VARIATIONS DURING EXCAVATIONS

(71) Applicant: China University of Mining and Technology, Jiangsu (CN)

(72) Inventors: Yu TANG, Jiangsu (CN); Gang SHEN, Jiangsu (CN); Jin CHANG, Jiangsu (CN); Gongbo ZHOU, Jiangsu (CN); Zhencai ZHU, Jiangsu (CN); Yongcun GUO, Jiangsu (CN); Ziming KOU, Jiangsu (CN); Juan WU, Jiangsu (CN); Zhiyuan SHI, Jiangsu (CN); Hao LU, Jiangsu (CN); Yuxing PENG, Jiangsu (CN); Qingguo WANG, Jiangsu (CN)

(73) Assignee: China University of Mining and Technology, Jiangsu (CN)

(21) Appl. No.: 18/840,914

(22) PCT Filed: Aug. 3, 2023
(86) PCT No.: PCT/CN2023/110954

§ 371 Date: Aug. 23, 2024

(30) Foreign Application Priority Data
Apr. 21, 2023 (CN) 202310436421.8

(51) Int. Cl. E21C 35/00; E02F 3/30; E02F 9/20; E21C 27/30; E21C 47/02; G06T 5/80; G06T 7/593; G06V 20/10

(52) U.S. Cl. CPC E21C 35/282; E02F 9/2041; E21C 47/02; G06T 5/80; G06T 7/593; G06V 20/10; E02F 3/308; E21C 27/30; G06T 2207/10012; G06T 2207/30181

(57) ABSTRACT

Disclosed is a method for controlling an automatic operation of a mining electric shovel considering sudden load variations during excavations, including performing a 3D reconstruction on the morphology features of the material pile to be excavated by using binocular cameras; selecting a function y_{w}=f_{w}(x,t) as the first excavation trajectory; monitoring the real-time volume of excavated materials in the bucket; recording the current position of the bucket tooth tip and the volume V1 of the excavated material, in a case where a large coal rock is monitored to exist in front of the bucket, and selecting the corresponding path planning scheme to avoid the large coal rock block; obtaining the current material pile surface function again; calculating the volume of the remaining excavated materials as the objective function for the second excavation; taking the ending point of the avoidance path as the starting point for the second excavation.

### TECHNICAL FIELD

The present disclosure relates to the technical field of mining machinery technology, and specifically relates to a method for controlling an automatic operation of a mining electric shovel considering sudden load variations during excavations.

### BACKGROUND

In order to promote the intelligent and unmanned operations of outdoor electric shovel, it is essential to ensure the fillability of the excavated materials in the bucket and the energy utilization efficiency of the mining electric shovel during a single excavation operation process. During the actual production, since the presence of the large blocks such as coal and rock in the excavated piles, the bucket may encounter these large coal rock blocks during the excavation process, which causes the secondary excavation trajectory of the bucket to deviate from the original planned excavation trajectory after the bucket avoids the coal and rock, resulting in the phenomena such as “shallow excavation” or “deep excavation”, thereby resulting in a problem that cannot guarantee the fillability of the bucket and the energy utilization efficiency of the mining electric shovel. Therefore, it is urgent to invent a method for controlling an automatic operation of a mining electric shovel considering sudden load variations during excavations.

### SUMMARY

The objectives of the present disclosure are to provide a method for controlling an automatic operation of a mining electric shovel considering sudden load variations during excavations, to solve the problem of excavation trajectory deviations in prior art.

In order to achieve above objectives, provided is a method for controlling an automatic operation of a mining electric shovel considering sudden load variations during excavations. And the method includes the following steps.

In Step S1, spatial coordinate systems are established at a joint of the mining electric shovel and a center of a binocular camera by taking O0, O1, O2, O3 as origins, respectively, and forward kinematics of a working device of the mining electric shovel are obtained through a D-H means.

In Step S2, a three-dimensional reproduction of morphology characteristics of a material pile to be excavated are performed by the binocular camera installed on the mining electric shovel.

In Step S3, an appropriate starting and ending positions for an excavation are selected by a three-dimensional model of the material pile in the Matlab, and a function y_{L}=f_{L}(x,t) of a material pile surface passed through during an excavation process are obtained.

In Step S4, a function y_{w}=f_{w}(x,t) is selected as a first excavation trajectory of the mining electric shovel, and an expected trajectory of a dipper arm elongation d and an expected trajectory of an inclination angle θ are obtained by using the forward kinematics of the mining electric shovel and a plane geometry relation.

In Step S5, dₜ is let to be a dynamic excavation depth of a mining electric shovel bucket, and dₜ=y_{L}−y_{w}=f_{L}(x,t)−f_{w}(x,t) is obtained, thereby a real-time volume of excavated materials in the bucket is

$${V}_{1} = {\int }_{0}^{t} ω {d}_{t} \dot{x} ( t ) dt , t ∈ ( 0 , {t}_{f} ) ;$$

where t_{f} denotes a time instant when the bucket leaves the material pile, and ω depends on a width of the mining electric shovel bucket.

In Step S6, in a case where a large coal rock block is monitored to exist in front of the bucket through a force sensor installed on a transmission part, a current position (x₀, y₀) of a bucket tooth tip and a volume V₁ of the excavated materials in the bucket are recorded and an excavation work is terminated.

In Step S7, a corresponding path planning scheme is selected in combination with an actual situation of an excavation operation obtained by the camera to avoid the large coal rock block in front of the excavation direction of the bucket.

In Step S8, a current material pile surface function y_{L2}=f_{L2}(x,t) is obtained again through the binocular camera.

In Step S9, a volume V2 of remaining excavated materials of the mining electric shovel bucket is calculated as an objective function for a second excavation.

In Step S10, an ending point of an avoidance path is taken as a starting point for the second excavation, and an excavation trajectory is re-planned to continue the excavation, thereby completing an entire excavation operation.

Further, in the spatial coordinate systems where the joint of the mining electric shovel and the center of the binocular camera are taken as the origins respectively. X₀, Y₀, X₁, Z₁, X₂, Z₂, X₃, and Y₃ are on the same plane, Z₀, Y₁, Y₂, and Z₃ are perpendicular to the plane, coordinate axes X₀ and X₃ are oriented horizontally to a right, coordinate axes Y₀ and Y₃ are oriented vertically upward, a coordinate axis X₁ is parallel to a coordinate axis X₂, a direction is along the shovel arm; the coordinate axis Z1 is parallel to the coordinate axis Z2, and the direction is along the shovel rod.

Further, a specific installing position of the binocular camera is at a center of a front side of the mining electric shovel boom.

Further, a means for extracting the morphological features of the excavated material pile specifically includes following steps.

Images of the excavated material pile are obtained, the images of material pile to be excavated are captured and obtained through the installed binocular camera.

Images are corrected, a distortion correction and a stereo correction are performed on the obtained images of the material pile.

Features are extracted, feature points are detected and extracted from left eye images of the material pile and right eye images of the material pile.

A stereo matching is performed, stereo matchings of the left eye images and the right eye images are completed by using the extracted feature points, and a disparity map of the material pile is obtained.

Voids are filled, invalid errors caused by an uneven lighting are handled by using a mean value filling means.

A disparity is converted to a depth, a processed disparity map is converted into a depth map through a geometric means.

A 3D reconstruction is performed, after the depth map is transformed into point cloud data through a coordinate transformation, the point cloud data are imported into Matlab are presented in a form of a stereo map.

Further, the material pile surface function y_{L}=f_{L}(x,t) is a curve function obtained by fitting a point cloud coordinate of the material pile distributed on an intermediate section of a bucket width direction using a least squares method.

Further, a first excavation trajectory of the mining electric shovel is selected as a logarithmic spiral ρ=ρ₀e^{φ cot δ}.

Further, the path planning scheme is that: according to a specific position of the large coal rock block in the material pile, in consideration of a distance situation between the large coal rock block and a ground as well as a distance situation between the large coal rock block and the material pile surface, three different avoidance paths, that is, an upward path, an alternating up and down path, and a downward path, are adopted.

Further, a method for calculating a volume of the remaining excavated materials of the bucket is V₂=V₀−V₁, where V0 denotes a bucket capacity of the mining electric shovel bucket.

Further, an ending point of the second excavation is obtained by simultaneously combining and inversely soluting V₂=V₀−V₁ and a volume formula for excavated materials in the bucket of the secondary excavation

$${V}_{2} = {\int }_{{x}_{0}}^{x} ω {d}_{t 2} dx = {\int }_{{x}_{0}}^{x} ω ( {k}_{2} ( {ρ}_{02} {e}^{φ cot {δ}_{2}} sin φ - {L}_{3} ) + {b}_{2} + {ρ}_{02} {e}^{φ cot {δ}_{2}} cos φ ) dx .$$

Further, a second excavation trajectory of the mining electric shovel is selected as a logarithmic spiral ρ=ρ₀e^{φ cot δ}.

The beneficial effects of the present disclosure are as follows.
(1) The present disclosure implements automatic and precise control on the mining electric shovel, which can effectively promote the intelligent and unmanned process of the mining electric shovel.
(2) The present disclosure utilizes machine vision and measure the volume of excavated material in the mining electric shovel bucket in a non-contact manner. Under a condition of not affecting the movement variations of each component of the working device of the mining electric shovel, the present disclosure can quickly implement real-time calculation of the volume of excavated material in the mining electric shovel bucket.
(3) The present disclosure takes the remaining excavated materials in the bucket as the objective function, which eliminates the phenomena such as “shallow excavation” or “deep excavation” in the planned re-excavation operation, ensuring both the fillability of the bucket and the energy utilization efficiency of the mining electric shovel.

### BRIEF DESCRIPTION OF THE DRAWINGS

FIG. 1 illustrates a flow chart diagram of a method for controlling an automatic operation of a mining electric shovel in the present disclosure.

FIG. 2 illustrates a schematic diagram of spatial coordinate systems of the mining electric shovel in the present disclosure.

FIG. 3 illustrates a plane geometric relation diagram between a polar diameter ρ, a polar angle φ, an elongation d, and an inclination angle θ of the present disclosure.

FIG. 4 illustrates a schematic diagram of a real-time volume solution principle for excavated materials in the bucket of the present disclosure.

FIG. 5 illustrates a schematic diagram of an optimization of a re-excavation trajectory of the mining electric shovel after avoiding coal and rock of the present disclosure.

### DETAILED DESCRIPTION OF THE EMBODIMENTS

The present disclosure will be specifically described in conjunction with the accompanying drawings and the specific embodiments.

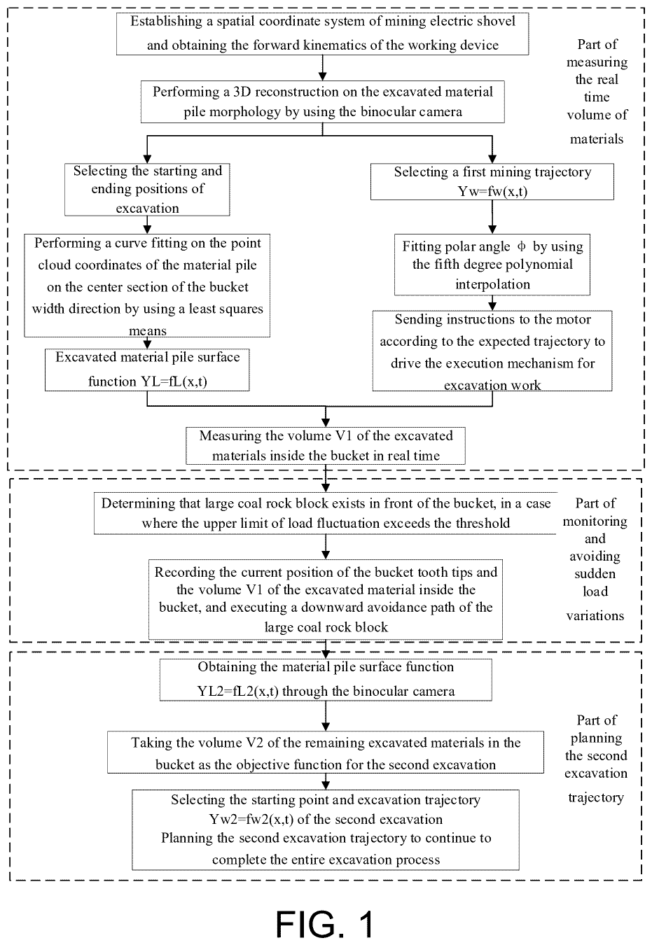

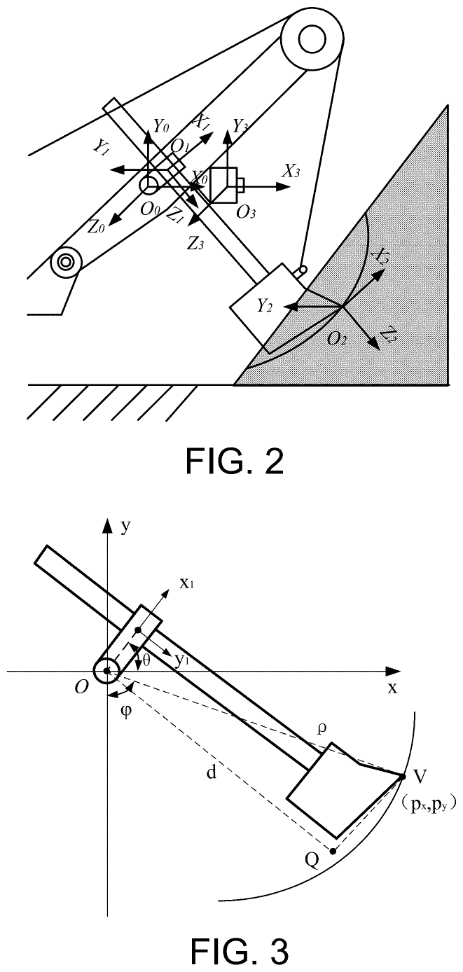

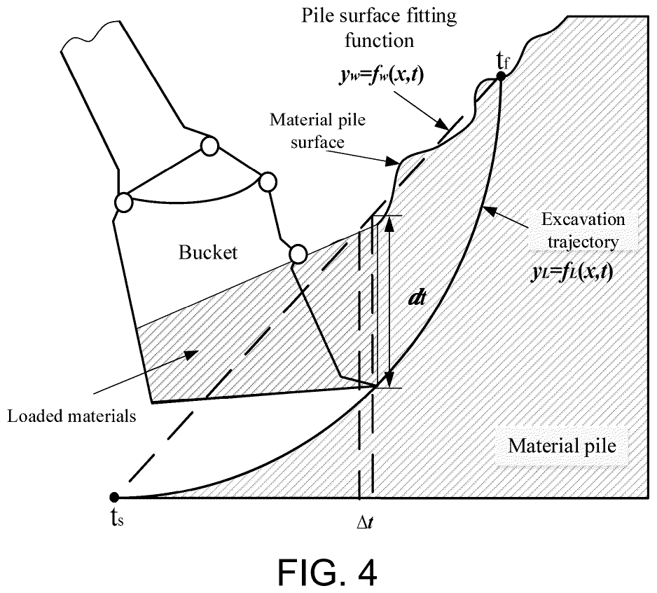

As illustrated in FIG. 1, provided is a method for controlling an automatic operation of a mining electric shovel considering sudden load variations during excavations. In order to facilitate the subsequent planning of the method for controlling the automatic operation, it is necessary to place the material pile surface function and excavation trajectory in the same coordinate system and solve the kinematic forward solution of the working device of the mining electric shovel. In view of this, the spatial coordinate system where the joint of the mining electric shovel and the center of the binocular camera are taken as the origins respectively is established as illustrated in FIG. 2. X₀, Y₀, X₁, Z₁, X₂, Z₂, X₃, and Y₃ are on the same plane, Z₀, Y₁, Y₂, and Z₃ are perpendicular to the plane, coordinate axes X₀ and X₃ are oriented horizontally to a right, coordinate axes Y₀ and Y₃ are oriented vertically upward, a coordinate axis X₁ is parallel to a coordinate axis X₂, a direction is along the shovel arm; the coordinate axis Z1 is parallel to the coordinate axis Z2, and the direction is along the shovel rod. It is assumed that θ denotes the angle at which the electric shovel rotates from the coordinate axis X₀ to the coordinate axis X₁ around the coordinate axis Z₀, L₁ denotes the distance along the coordinate axis X₁ between the origin O₀ of the joint 0 coordinate system and the origin O₁ of the joint 1 coordinate system, d denotes the distance along the Z₂ coordinate axis between the origin O₁ of the joint 1 coordinate system and the origin O₂ of the joint 2 coordinate system, L₂ denotes the distance along the Z₂ coordinate axis between the origin O₁ of the joint 1 coordinate system and the origin O₂ of the joint 2 coordinate system, and L₃ denotes the distance along the X₃ coordinate axis between the origin O₀ of the joint 0 coordinate system and the origin O₃ of the binocular camera coordinate system.

After the coordinate system is transformed once, the corresponding transformation matrix is solved, that is, the pose transformation from the origin O₃ of the binocular camera coordinate system to the origin O₀ of the joint 0 coordinate system, thus achieving the goal of placing the point cloud of the material pile surface and the excavation trajectory in the same coordinate system. The DH parameter table as shown in Table 1 is obtained by the established coordinate system, and the DH parameter table is as shown in Table 1.

TABLE 1
D-H Parameter Table of Working Device
of Mining Electric Shovel

| Joint i | dᵢ | θᵢ | aᵢ | αᵢ |
|---|---|---|---|---|
| 1 | 0 | θ | L₁ | 90° |
| 2 | d | 0 | L₂ | 0 |

The coordinate system with O₀ as the origin is transformed twice into the coordinate system with O₂ as the origin, and the pose transformation matrix T from the saddle to the bucket tooth tip is obtained. Therefore, the forward kinematics of the working device of the mining electric shovel is

$$\{ \begin{matrix}{p}_{x} = {L}_{2} cos θ + d sin θ + {L}_{1} cos θ \\ {p}_{y} = {L}_{2} sin θ - d cos θ + {L}_{1} sin θ\end{matrix} .$$

The Visual Studio is used to call the camera to capture images of the excavated material pile, and then images are corrected, features are extracted, a stereo matching is performed, voids are filled, and depth is converted to obtain the txt point cloud data file of the excavated material pile. The txt point cloud data file of the excavated material pile obtained above is imported into Matlab and is present in the form of a 3D image. An appropriate excavation starting point (xₛ, yₛ) and an appropriate excavation ending point (xₛ, yₛ) can be selected by the operators according to the current morphology of the excavated material pile. The point cloud coordinates distributed on the intermediate section of the bucket width direction are simultaneously filtered out, and these point cloud coordinates are exported. After removing points with numerical anomalies, the type of curve to be fitted and the number of parameters to be fitted are set, and the least squares mean is utilized to begin to fit the mining material pile surface function y_{L}=f_{L}(x,t). The fitting function type is preferably selected as a linear function y_{L}=kx+b herein. One coordinate system transformation is performed to convert the material pile surface function from a coordinate system with O₃ as the origin to a coordinate system with O₀ as the origin. And at this time, the material pile surface function is y_{L}=k(x−L₃)+b.

A certain function y_{w}=f_{w}(x,t) is selected as the first excavation trajectory of the mining electric shovel, a logarithmic spiral line ρ=ρ₀e^{φ cot δ} is preferably selected herein, where ρ₀ denotes the initial elongation of the dipper arm and δ denotes the cutting angle. Convert to the mining trajectory function in the base coordinate system. ρ0 and δ are converted into the excavation trajectory function in the base coordinate system and are expressed as

$$\{ \begin{matrix}x = {ρ}_{0} {e}^{φ cot δ} sin φ \\ y = - {ρ}_{0} {e}^{φ cot δ} cos φ\end{matrix} .$$

In order to ensure a smooth excavation trajectory without sudden speed variations, and the excavation can be smoothly stopped during electric shovel excavation operations, it is necessary to satisfy φ(0)=φ₀, φ(t_{f})=φ_{f}, \dot{φ}(0)=0, \dot{φ}(t_{f})=0, \ddot{φ}(0)=0, \ddot{φ}(t_{f})=0, where φ(t), \dot{φ}(t), φ₀, φ_{f}, t_{f} denote the angular displacement, the angular velocity, the angular acceleration, the excavation initial angle, the termination angle, and the end time of bucket tooth tip, respectively. According to the conditions that need to be satisfied for a stable excavation of the mining electric shovel, a 5th degree polynomial is selected to interpolate and fit the tooth tip angle of the mining electric shovel bucket, that is, the polar angle φ, to obtain the functional relation of the polar angle φ relating to time t:

$$φ ( t ) = {φ}_{0} + \frac{10 ( {φ}_{f} - {φ}_{0} )}{{t}_{f}^{3}} {t}^{3} + \frac{- 15 ( {φ}_{f} - {φ}_{0} )}{{t}_{f}^{4}} {t}^{4} + \frac{6 ( {φ}_{f} - {φ}_{0} )}{{t}_{f}^{5}} {t}^{5} .$$

According to the kinematic forward solution of the working device of the mining electric shovel obtained above and the geometric relation as illustrated in FIG. 3, the expressions of p and φ relating to pₓ and p_{y} are obtained and expressed as

$$ρ = \sqrt{{p}_{x}^{2} + {p}_{y}^{2}} , tan φ = \vert \frac{{p}_{x}}{{p}_{y}} \vert .$$

Then, the relation expression between the polar diameter ρ and polar angle φ as well as the elongation d and inclination angle θ is obtained and expressed as

$$\{ \begin{matrix}d = \sqrt{{ρ}^{2} - {( {L}_{1} + {L}_{2} )}^{2}} \\ θ = arctan \frac{d}{{L}_{1} + {L}_{2}} - ( \frac{π}{2} - φ )\end{matrix} .$$

From this, the function d(t) of the dipper arm elongation d relating to time t and the function θ(t) of the inclination angle θ relating to time t can be obtained. Instructions are sent to a variable frequency alternating current motors through the expected trajectory of a dipper arm elongation d and the expected trajectory of the inclination angle θ, and an execution mechanism of the mining electric shovel are driven to carry out an excavation work.

At the same time, the volume measurement system for excavated materials in the bucket begins to work, and its working principle is as illustrated in FIG. 3. Since at an arbitrary time instant during the entire excavation process, the X-axis coordinate of the material pile surface function is the same as the X-axis coordinate of the excavation trajectory function, that is, the X-axis coordinate of the material pile surface function can be expressed as x=ρ₀e^{φ cot δ} sin φ. Therefore, according to the formula dₜ=y_{L}−y_{w}=k(ρ₀e^{φ(t)cot δ} sin φ(t)−L₃)+b+ρ₀e^{φ(t)cot δ} cos φ(t), the dynamic excavation depth di of the mining electric shovel bucket can be obtained, and then the real-time volume formula of the excavated material can be solved by using the principle of indefinite integration:

$${V}_{1} = {\int }_{{x}_{0}}^{x} ω {d}_{t} dx = {\int }_{0}^{t} ω ( k ( {ρ}_{0} {e}^{φ ( t ) cot δ} sin φ ( t ) - {L}_{3} ) + b + {ρ}_{0} {e}^{φ ( t ) cot δ} cos φ ( t ) ) \cdot {ρ}_{0} {e}^{φ ( t ) cot δ} \dot{φ} ( t ) ( cot δ sin φ ( t ) + cos φ ( t ) ) dt , t ∈ ( 0 , {t}_{f} ) ,$$

which can quickly measure the excavated material in the bucket in real time during the excavation process and send the numerical value to the human-computer interaction interface.

During the excavation process, the real-time excavation resistance can be obtained by the force sensors respectively installed at the connection between the bucket and the end of the lifting rope, as well as between the pushing motor and the synchronous pulley. It is monitored that whether the fluctuation upper limit of the reading of the sensor exceeds the specified threshold, in a case where the readings of the force sensors suddenly increase and exceed the specified threshold, it indicates that the tooth tip of the mining electric shovel bucket is in contact with a large coal rock block. After the current coordinate (x₀, y₀) of the bucket tooth tip and the volume V₁ₜ₌ₜ_{₀}, of excavated material in the bucket are recorded, the mining electric shovel terminates the excavation work and begins to execute instructions to avoid the large coal rock block.

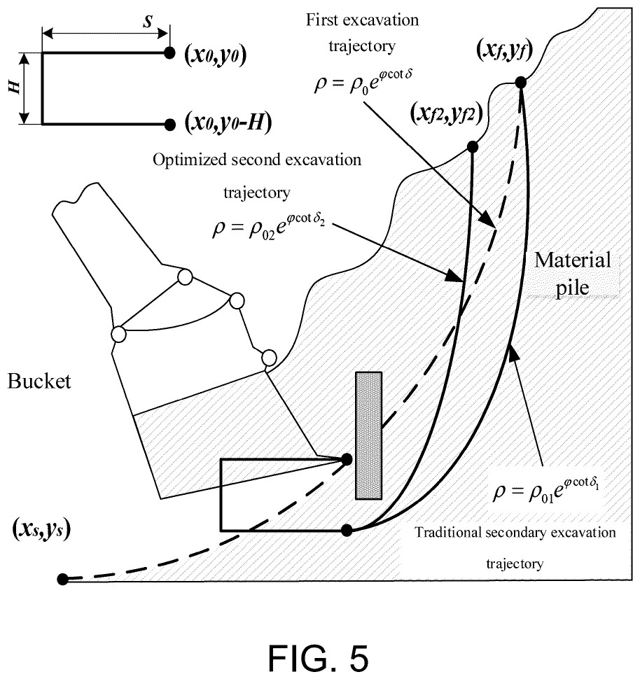

Executing an instruction to avoid a path once is taken as a specific embodiment herein, and the specific operations are as illustrated in FIG. 5: Firstly, the bucket tooth tip is moved horizontally backward by a distance S. Subsequently, the bucket tooth tip is moved vertically downwards by a distance H. Eventually, the bucket tooth tip is moved horizontally forwards by a distance S to a point (x₀, y₀−H) directly below a first excavation stop point (x₀, y₀). At the same time, the readings of the force sensor are monitored to be not exceed the threshold, indicating successful avoidance of the large coal rock blocks.

Subsequently, the ending point (x₀, y₀−H) of the avoidance path is taken as the starting point for the second excavation, and the logarithmic spiral ρ=>₀₂e^{φ cot δ}^{₂} is selected a as the excavation trajectory, and the excavation trajectory is converted into

$$\{ \begin{matrix}x = {ρ}_{02} {e}^{φ cot {δ}_{2}} sin φ \\ y = - {ρ}_{02} {e}^{φ cot {δ}_{2}} cos φ\end{matrix}$$

in the base coordinate system. The binocular camera is utilized to obtain the material pile surface function y_{L2}=f_{L2}(x,t)=k₂x+b₂ of the at the current time instant. Since at any time instant in the second excavation, the X-axis coordinate of the material pile surface function is the same as that of the excavation trajectory function, that is, the X-axis coordinate of the material pile surface function can be expressed as x=ρ₀₂e^{φ cot δ}^{₂} sin φ. Therefore, according to the formula dₜ₂=y_{L2}−y_{w2}=k₂(ρ₀₂e^{φ cot δ}^{₂} sin φ−L₃)+b₂+ρ₀₂e^{φ cot δ}^{₂} cos φ, the dynamic excavation depth dₜ of the mining electric shovel bucket can be obtained, and then the formula for excavating material volume can be solved by using the principle of indefinite integration, and the formula is expressed

$${V}_{2} = {\int }_{{x}_{0}}^{x} ω {d}_{t 2} dx = {\int }_{{x}_{0}}^{x} ω ( {k}_{2} ( {ρ}_{02} {e}^{φ cot {δ}_{2}} sin φ - {L}_{3} ) + {b}_{2} + {ρ}_{02} {e}^{φ cot {δ}_{2}} cos φ ) dx .$$

And V₂=V₀−V₁ₜ₌ₜ_{₀}, thus the coordinates (x_{f2}, y_{f2}) of the ending point of the second excavation can be obtained. The starting point (x₀, y₀−H) of the second excavation is known, two sets of the coordinates (ρ₀, φ₀) (ρ_{f2}, φ_{f2}) are obtained through geometric relation expression

$$ρ = \sqrt{{p}_{x}^{2} + {p}_{y}^{2}} , tan φ = \vert \frac{{p}_{x}}{{p}_{y}} \vert .$$

The two sets of the coordinates are respectively input into the excavation trajectory function ρ=ρ₀e^{φ cot δ} to have

$$\{ \begin{matrix}{ρ}_{0} = {ρ}_{02} {e}^{{φ}_{0} cot {δ}_{2}} \\ {ρ}_{f 2} = {ρ}_{02} {e}^{{φ}_{f 2} cot {δ}_{2}}\end{matrix} ,$$

and the initial elongation and cutting angle of the second excavation trajectory can be obtained by solving the

$$\{ \begin{matrix}{ρ}_{0} = {ρ}_{02} {e}^{{φ}_{0} cot {δ}_{2}} \\ {ρ}_{f 2} = {ρ}_{02} {e}^{{φ}_{f 2} cot {δ}_{2}}\end{matrix} .$$

As above, by utilizing the forward kinematics of the working device of the mining electric shovel and the geometric relation as illustrated in FIG. 2, the dipper arm elongation d(t) and an expected trajectory of an inclination angle θ(t) are obtained, and the variable frequency AC motor is driven to work, thus the entire excavation operation is continued to be completed.

The embodiments of the present disclosure are described in detail above in conjunction with the accompanying drawings, while the present disclosure is not limited to this. Various variations that can be made within the knowledge scope of those skilled in the art without departing from the purpose of the present disclosure are all within the protection scope of the claims of the present disclosure.

1. A method for controlling an automatic operation of a mining electric shovel considering sudden load variations during excavations, the method comprising following steps:
Step S1, establishing, by taking O0, O1, O2, O3 as origins, spatial coordinate systems at joints of the mining electric shovel and a center of a binocular camera, respectively, and obtaining, through a D-H means, forward kinematics of a working device of the mining electric shovel;
Step S2, performing, by the binocular camera installed on the mining electric shovel, a three-dimensional reproduction of morphology characteristics of a material pile to be excavated;
Step S3, selecting, by a three-dimensional model of the material pile in a Matlab, an appropriate starting and ending positions for an excavation, and obtaining a function y_{L}=f_{L}(x,t) of a material pile surface passed through during an excavation process;
Step S4, selecting a function y_{w}=f_{w}(x,t) as a first excavation trajectory of the mining electric shovel, and obtaining, by using the forward kinematics of the mining electric shovel and a geometry relation, an expected trajectory of a dipper arm elongation d and an expected trajectory of an inclination angle θ;
Step S5, letting dₜ be a dynamic excavation depth of a mining electric shovel bucket, and having dₜ=y_{L}−y_{w}=f_{L}(x,t)−f_{w}(x,t), thereby a real-time volume of excavated materials in a bucket being
$${V}_{1} = {\int }_{0}^{t} ω {d}_{t} \dot{x} ( t ) dt , t ∈ ( 0 , {t}_{f} ) ;$$
where t_{f} denotes a time instant when the bucket leaves the material pile, and ω depends on a width of the mining electric shovel bucket;
Step S6, recording, in a case where a large coal rock block is monitored to exist in front of the bucket through a force sensor installed on a transmission part, a current position (x₀, y₀) of a bucket tooth tip and a volume V₁ of the excavated materials in the bucket, and terminating an excavation work;
Step S7, selecting, in combination with an actual situation of an excavation operation obtained by a camera, a corresponding path planning scheme, to avoid the large coal rock block in front of an excavation direction of the bucket;
Step S8, obtaining, through the binocular camera, a current material pile surface function y_{L2}=f_{L2}(x,t) again;
Step S9, calculating a volume V2 of remaining excavated materials of the mining electric shovel bucket as an objective function for a second excavation; and
Step S10, taking an ending point of an avoidance path as a starting point for the second excavation, re-planing an excavation trajectory to continue the excavation, thereby completing an entire excavation operation.

2. The method for controlling the automatic operation of the mining electric shovel considering the sudden load variations during excavations according to claim 1, wherein in the spatial coordinate systems where the joints of the mining electric shovel and the center of the binocular camera are taken as the origins respectively, X₀, Y₀, X₁, Z₁, X₂, Z₂, X₃, and Y₃ are on a same plane, Z₀, Y₁, Y₂, and Z₃ are perpendicular to the plane, coordinate axes X₀ and X₃ are oriented horizontally to a right, coordinate axes Y₀ and Y₃ are oriented vertically upward, a coordinate axis X₁ is parallel to a coordinate axis X₂ with a direction along a shovel arm; a coordinate axis Z₁ is parallel to a coordinate axis Z₂ with a direction along a shovel rod.

3. The method for controlling the automatic operation of the mining electric shovel considering the sudden load variations during excavations according to claim 1, wherein a specific installing position of the binocular camera is at a center of a front side of an arm of the mining electric shovel.

4. The method for controlling the automatic operation of the mining electric shovel considering the sudden load variations during excavations according to claim 1, wherein a means for extracting the morphological features of the excavated material pile comprises following steps:
obtaining images of the excavated material pile, capturing and obtaining, through the installed binocular camera, images of material pile to be excavated;
correcting the images, performing a distortion correction and a stereo correction on the obtained images of the material pile;
extracting features, detecting and extracting feature points from a left eye image of the material pile and a right eye image of the material pile;
performing a stereo matching, completing, by using the extracted feature points, stereo matchings of the left eye image and the right eye image, and obtaining a disparity map of the material pile;
filling voids, handling, by using a mean value filling means, invalid errors caused by uneven lighting;
converting a disparity to a depth, converting, through a geometric means, a processed disparity map into a depth map; and
performing a 3D reconstruction, importing, after the depth map is transformed into point cloud data through a coordinate transformation, the point cloud data into the Matlab, and presenting in a form of a stereo map.

5. The method for controlling the automatic operation of the mining electric shovel considering the sudden load variations during excavations according to claim 1, wherein the function y_{L}=f_{L}(x,t) is a curve function obtained by fitting a point cloud coordinate of the material pile distributed on an intermediate section of a bucket width direction using a least squares method.

6. The method for controlling the automatic operation of the mining electric shovel considering the sudden load variations during excavations according to claim 1, wherein a first excavation trajectory of the mining electric shovel is selected as a logarithmic spiral ρ=ρ₀e^{φ cot δ}.

7. The method for controlling the automatic operation of the mining electric shovel considering the sudden load variations during excavations according to claim 1, wherein the path planning scheme is that: according to a specific position of the large coal rock block in the material pile, in consideration of a distance situation between the large coal rock block and a ground as well as a distance situation between the large coal rock block and the material pile surface, three different avoidance paths, that is, an upward path, an alternating up and down path, and a downward path, are adopted.

8. The method for controlling the automatic operation of the mining electric shovel considering the sudden load variations during excavations according to claim 1, wherein a method for calculating a volume of the remaining excavated materials of the bucket is V₂=V₀−V₁, where V₀ denotes a bucket capacity of the mining electric shovel bucket.

9. The method for controlling the automatic operation of the mining electric shovel considering the sudden load variations during excavations according to claim 1, wherein an ending point of the second excavation is obtained by simultaneously combining and inversely soluting V₂=V₀−V₁ and a volume formula for excavated materials in the bucket of the secondary excavation
$${V}_{2} = {\int }_{{x}_{0}}^{x} ω {d}_{t 2} dx = {\int }_{{x}_{0}}^{x} ω ( {k}_{2} ( {ρ}_{02} {e}^{φ cot {δ}_{2}} sin φ - {L}_{3} ) + {b}_{2} + {ρ}_{02} {e}^{φ cot {δ}_{2}} cos φ ) dx .$$

10. The method for controlling the automatic operation of the mining electric shovel considering the sudden load variations during excavations according to claim 1, wherein a second excavation trajectory of the mining electric shovel is selected as a logarithmic spiral ρ=ρ₀e^{φ cot δ}.
